(19) United States
(12) Patent Application Publication
(10) Pub. No.: US 2003/0176164 A1
(43) Pub. Date: Sep. 18, 2003

(54) Radiation protection device

(76) Inventor: Yaron Hefetz, Herzliya (IL)

Correspondence Address: Yaron Hefetz, Hanallie Rozen, 1551 B Street, Sprinfield, OR, 97477, US

(21) Appl. No.: 10/344,788

(22) PCT Filed: Aug. 15, 2001
(86) PCT No.: PCT/IL01/00762

(30) Foreign Application Priority Data
Aug. 15, 2000 (IL) 137874

(51) Int. Cl. H04H 7/00

(52) U.S. Cl. 455/3.06; 455/550.1

(57) ABSTRACT

A headset for protecting a user of audio equipment from radiation emitted by the equipment, and a method therefore, the headset including: (a) at least one earphone; (b) a cord operatively connected at a first end to the earphone, and operatively connected at a second end to the audio device, and (c) a radio-frequency (RF) wave attentuating device, the RF wave attenuating device disposed so as to reduce the radiation emitted via the audio device to the sensitive organ.

### FIELD AND BACKGROUND OF THE INVENTION

The present invention relates to radiation protection devices and, in particular, to a device for reducing the amount of radiation emitted from an earpiece of audio equipment.

Cellular phones have become widely used in recent years. In the wake of this trend, there is growing concern about the health hazards involved in the use of such communication devices. One main concern is radio-frequency radiation emitted by the antenna of the cellular phone in close proximity to the brain of the user. Although the exact mechanism and severity of the hazard is not fully known at this time, it has been widely recommended by the medical community to reduce the radiation level absorbed by the brain.

Various devices are currently available that allegedly offer some protection from such a radiation hazard. These devices are grouped into two main categories:

1) Radiation blocking or radiation absorbing devices disposed around the antenna to reduce the radio frequency (RF) radiation emitted from the cellular phone in the direction of the sensitive organs of the user.

Studies show that these devices have little impact, achieving a reducing radiation levels by 25% at most. Moreover, many modern cellular phones detect the decrease in emission and the corresponding reduction in connection quality and compensate by increasing the transmission level in order to maintain sound quality. [Since the operation of the phone is based on transmitting and receiving RF energy, any interference with its ability to transmit or receive radiation has adverse effect on communication quality.

2) Devices that allow the cellular phone to be used at a greater distance from the sensitive organs.

The purpose of these devices is to reduce the radiation level by placing the RF-radiating parts (mainly the antenna) away from the body. Since the antenna is usually an integral part of the phone, the antenna is in close proximity to the head during normal use. Moreover, it is difficult to increase the distance between the phone and the head of the user because the phone must be held close to the ear in order to hear well. Foam pads are attached to the speaker which increase the distance between the antenna and the brain. These devices give very limited protection due to the slight (1 cm or less) increase of the distance between the head and the radiation source. A typical distance between the cellular phone and the user brain is 5 cm. Since the radiation field decreases inversely to the square of the distance, a properly used headset may offer a protection factor of 5²/6² or reduction to 70% of the original exposure level. These calculations are optimistic since at these short distances the field has not reached the “far field” behavior, such that the inverse square law is inaccurate.

The use of a headset in conjunction with a cellular phone is one approach to increasing the distance between the RF-emitting antenna of the cellular phone, and the sensitive body organs requiring radiation protection. Typically, the length of a headset cord is about 100 cm, such that the distance between the head of the user and the antenna can be increased from about 5 cm to over 50 cm. Since the radiation field decreases inversely to the square of the distance, a properly used headset may offer a protection factor of (5/50)² or 1% of the original exposure level.

Headsets are widely used with cellular phone and other digital audio equipment. Headsets offer good sound quality, some blocking of background noise and have the added benefit of hands-free operation. These devices contain one or two earphones for inserting into the outer ear, and sometimes include a microphone and/or various control switches or dials. An electrical cord usually connects the headset to the body of the cellular phone or the audio source.

Although such headsets have been touted as greatly reducing radiation hazards by distancing the antenna from the head of the user, recent studies have shown that the electrical conductors within the cord actually transmit dangerous RF energy directly to the earphone, which is inserted into the user's ear or is placed very close the ear. Since the RF field increases in inverse proportion to the square of the distance from the radiation source, and since the earphone is placed very near the brain, the potential hazard in using a headset may be large even if only a small fraction of the total RF energy is coupled into its cord.

RF energy can be coupled to the cord by parasitic coupling at the connector end, or through induction from the antenna. Thus, even if a small percentage of the antenna radiation is coupled to the headset cord and transmitted to the proximity of the ear, the health benefit of using headset may not be realized with the current design. On the contrary, it can be shown that in many instances, the total RF energy reaching the brain when using an earpiece is greater than the radiation that would have been absorbed by the brain if the phone were used without an ear piece. For example, using the above-mentioned inverse square law, a radiation source at 1 cm from the brain (e.g., using an earphone) produces a radiation field at the brain having 2.5 times the intensity of the field produced at the brain by an antenna disposed 5 cm from the brain and having 10 times the RF energy.

Modern radio receivers use high-frequency local oscillators for heterodyne detection and or digital control and signal processing units, such that they too are a harmful source of RF energy. Various other kinds of digital audio equipment are known to emit radio frequency radiation. For example, the operation of CD players, MP3 players, video games and personal computers is banned during takeoff and landing of commercial airlines, due to the strong RF emission of these devices, which interferes with navigation equipment on the airplane. As elaborated hereinabove, earphones and headsets used in conjunction with these devices offer no significant protection against harmful RF radiation.

In an investigative article in the Israeli consumer's monthly magazine “BADUK” (Jul. 29, 2000) the inadequacies of various commercial, allegedly-protecting devices are reviewed.

There is therefore a recognized and acute need for, and it would be highly advantageous to have, a device that appreciably reduces the level of RF radiation in the vicinity of the brain of the user of cellular phones and other types of digital audio equipment. It would be of further advantage if such a device would be simple, compact, efficient, inexpensive and can be added to existing equipment.

### SUMMARY OF THE INVENTION

The present invention is a headset for protecting a user of audio equipment from radiation emitted by the equipment, the headset including: (a) at least one earphone; (b) a cord operatively connected at a first end to the earphone, and operatively connected at a second end to the audio device, and (c) a radio-frequency (RF) wave attenuating device, the RF wave attenuating device disposed so as to reduce the radiation emitted via the audio device to the sensitive organ.

According to another aspect of the present invention there is provided a method of protecting a sensitive organ of a user of audio equipment, the method including the steps of: (a) providing the audio equipment, the equipment including a signal-emitting device and a headset; (b) transmitting a signal from the signal-emitting device to the headset, and (c) disposing a radio-frequency damping device such that radiation emitted by the signal-emitting device is reduced in the immediate vicinity of the sensitive organ.

According to further features in the described preferred embodiments, the audio equipment is a mobile or cellular phone.

According to still further features in the described preferred embodiments, the damping device is a radiation filtering device.

According to still further features in the described preferred embodiments, the damping device is a radiation blocking device.

According to still further features in the described preferred embodiments, the radiation blocking device includes ferrite.

According to still further features in the described preferred embodiments, the damping device is disposed on a cord connecting the signal-emitting device and the headset.

According to still further features in the described preferred embodiments, the RF wave attenuating device is operatively connected to the cord.

According to still further features in the described preferred embodiments, the sensitive organ is a brain of the user.

According to still further features in the described preferred embodiments, the RF wave attenuating device is substantially ring-shaped.

According to still further features in the described preferred embodiments, the RF wave attenuating device is substantially bead-shaped.

According to still further features in the described preferred embodiments, the RF wave attenuating device includes RF blocking electronic circuitry, the circuitry being electrically connected to the cord.

According to still further features in the described preferred embodiments, the RF blocking electronic circuitry includes a capacitor, a resistor, and an inductor wired together as a network.

According to still further features in the described preferred embodiments, the RF blocking electronic circuitry is a filter tuned to block the frequency of the communication device.

According to still further features in the described preferred embodiments, the RF wave attenuating device is an integral part of a connector connecting the cord to the RF wave attenuating device.

According to still further features in the described preferred embodiments, the RF wave attenuating device is an integral part of a microphone assembly disposed on the cord.

According to still further features in the described preferred embodiments, the RF wave attenuating device is an integral part of the cord, the RF wave attenuating device enveloping electric conductors running along a length of the cord.

According to still further features in the described preferred embodiments, the RF wave attenuating device includes a sound conducting tube made of a radio frequency inhibiting material.

The present invention successfully addresses the shortcomings of the existing technologies by providing a device for use in conjunction with cellular phones and other types of digital audio equipment having headsets, which appreciably reduces the level of RF radiation in the vicinity of the brain of the user. The present invention is simple, reliable and inexpensive, and provides a genuine, effective solution to the problem of exposure to RF radiation.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a cellular phone with headset attached and at least one radio-frequency blocking device attached to the cord;

FIG. 2 shows a cellular phone with headset attached, wherein a radio-frequency blocking device is part of the connector unit;

FIG. 3 shows a radio-frequency blocking filter for attaching to the cord of a headset;

FIG. 4a is a cross section of a prior-art cord;

FIGS. 4b-4d are cross sections of cords provided with a radio-frequency attenuating material;

FIGS. 5a and 5b show headsets having hollow tubes for reduction of RF radiation, and

FIG. 6 shows a cellular phone with a remote antenna.

### DESCRIPTION OF THE PREFERRED EMBODIMENTS

The present invention is a device for use in conjunction with cellular phones and other types of digital audio equipment having headsets, which significantly reduces the level of RF radiation in the vicinity of the brain of the user, without interfering with communication quality.

The principles and operation of the device according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

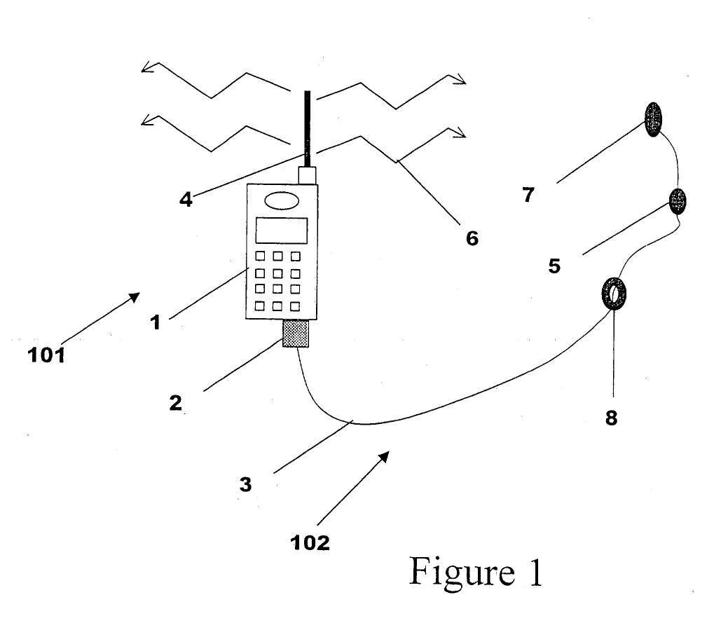

FIG. 1 shows a cellular phone or other audio equipment (101) with a headset (102) attached to a cellular phone housing (1) via a connector (2). At least one radio-frequency blocking device (8) is attached to a cord (3). RF radiation (6) is emitted from an antenna (4) attached to housing (1) and is efficiently coupled to cord (3) located at close proximity to antenna (4). RF radiation (6) is blocked or attenuated or reflected back by RF attenuating device (8). Thus, the RF radiation that is radiated from earpiece (7) is weak, such that the health risk associated with the insertion of earpiece (7) into the ear of a user is strongly reduced.

The RF attenuating device may be integrated into earpiece (7) or alternatively, into a microphone or control assembly (5) commonly used in cellular phones, CD players and MP3 music players.

The RF attenuating device may be in a form of a ring, and is preferably made of ferrite or another RF attenuating material. The cord is inserted through the ring or is wound around the ring few times. The ring can be constructed from a few parts to be assembled around the cord for easy installation by the user. Alternatively, the ring can be assembled during the manufacturing of the headset.

Various shapes for such a radio-frequency attenuating device are known to those skilled in the art.

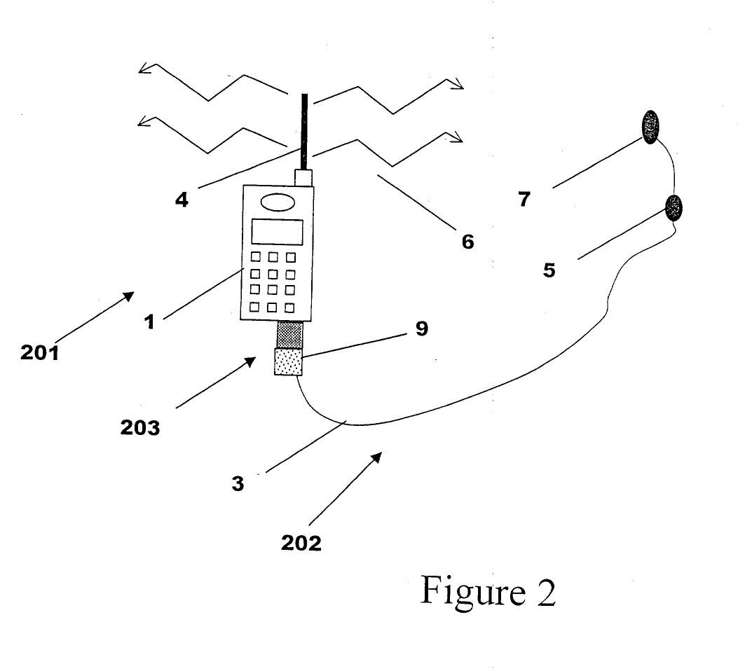

FIG. 2 shows a cellular phone or other audio equipment (201) with headset (202) attached. A radio-frequency blocking device (9) is part of a cord connector (203) that connects cord (3) with cellular phone housing (1). This configuration is best used with digital audio or entertainment equipment in which most of the RF radiation is due to parasitic coupling through cord connector (203). The filter could be integrated into either side of the headset connector or both.

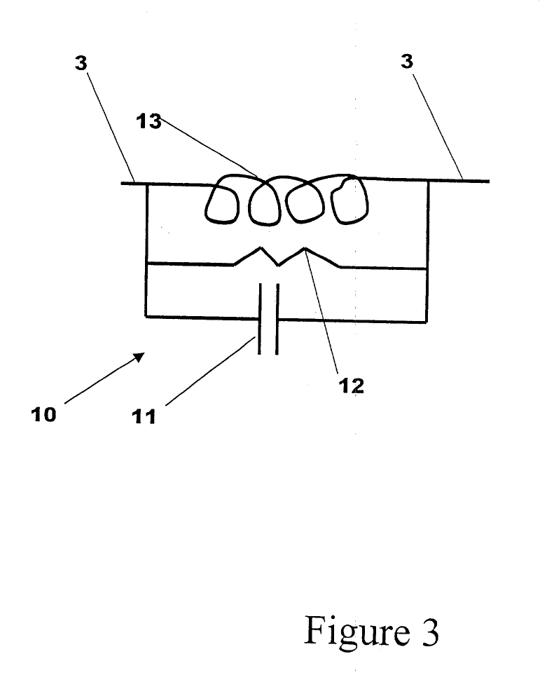

FIG. 3 shows a radio-frequency blocking filter (10) for attaching to the cord (3) of a headset (not shown). Radio-frequency blocking filter (10) includes an inductor (13), a capacitor (11) and a resistor (12) in a network configuration. The filter may be tuned to provide high attenuation in a specific band or bands of radio-frequencies in which the audio equipment is known to emit, while providing adequate transmission for the low frequency audio signal. Alternatively, the filter may be a low pass filter.

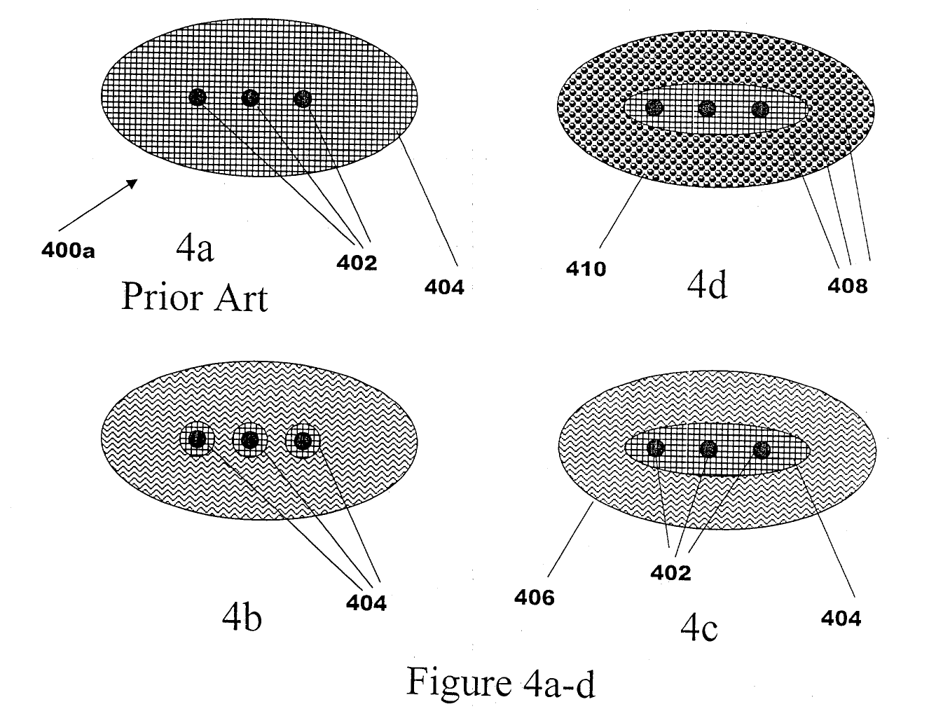

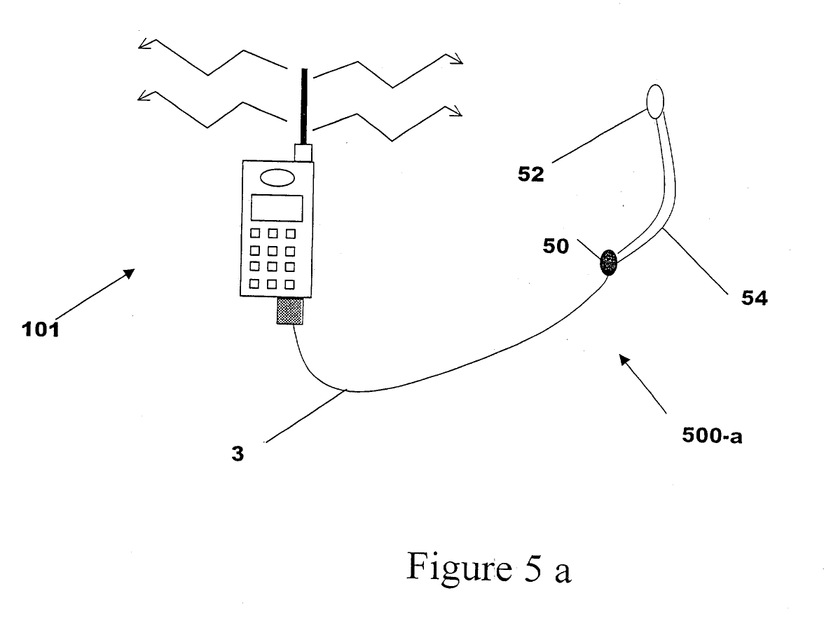

FIG. 4a is a schematic cross-section of a standard, prior-art cord (400a) having metallic electric conductors (402) surrounded by an insulator (404). RF radiation can easily propagate along this kind of cord.

FIGS. 4b, 4c and 4d provide schematic cross-sections of exemplary preferred embodiments in which a radio-frequency attenuating material is an integral part of the cord coating. In FIG. 4c, metallic conductors (402) are surrounded by an insulation layer (404) which is, in turn, surrounded by a radio-frequency attenuating material (406). Alternatively, each conductor may be individually enveloped by an insulation layer (404) as shown in FIG. 4b.

FIG. 4d shows a similar construction in which a radio-frequency attenuating layer includes a flexible polymer layer (410) within which RF attenuating particles (408) are imbedded.

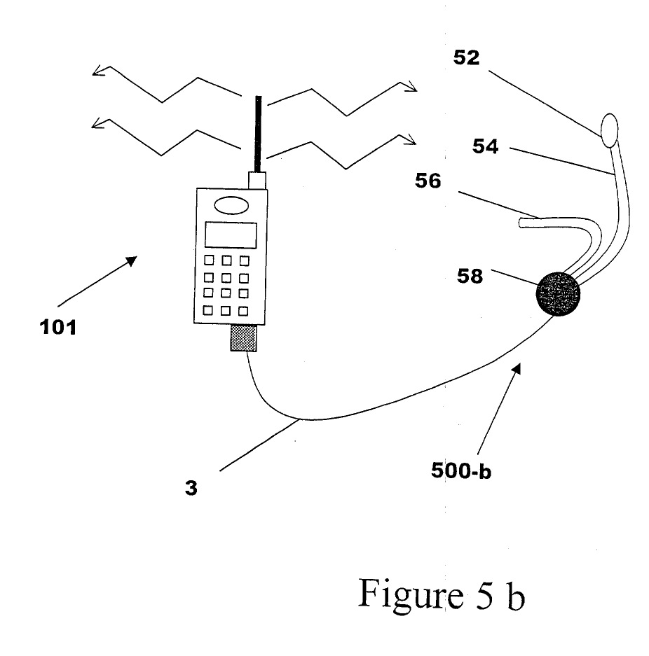

FIG. 5a shows a headset (500-a) connected to a cellular phone (101) by means of a cord (3). Cord (3) is connected at the opposite end to a speaker-like device (50), to which is attached a hollow tube (54) for conducting sound waves from speaker-like device (50) to an ear piece (52). The tube is preferably made of a substantially non-conductive or poorly conductive material, such that the RF radiation reaching the proximity of the brain of the user is substantially reduced.

FIG. 5b shows a similar headset (500-b) specifically designed for a personal communication device in which (in addition to tube (54), which carries sound from the speaker to the earpiece (52)) sound waves are carried from the proximity of the mouth of the user, by way of tube (56), to a remote microphone (58). The speaker, microphone and control switches and a dial may be integrated into one unit, if desired.

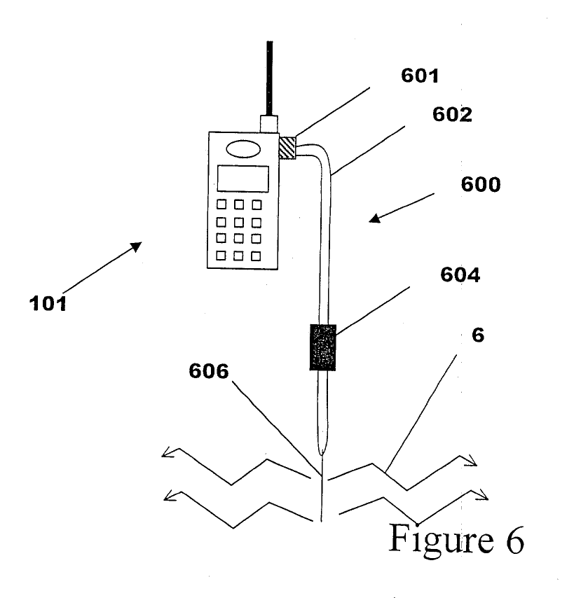

FIG. 6 shows a cellular phone (101) with a remote antenna (600) attached by way of connector (601). The shielded cord (602), which is optionally equipped with a radio-frequency blocking device (604), transmits the RF energy to a radiating section (606) disposed such that radiation field (6) is generated at a substantial distance from the brain of the user.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications mentioned in this specification are herein incorporated in their entirety by reference into the specification, to the same extent as if each individual publication was specifically and individually indicated to be incorporated herein by reference. In addition, citation or identification of any reference in this application shall not be construed as an admission that such reference is available as prior art to the present invention.

What is claimed is:

1. A method of protecting a sensitive organ of a user of audio equipment, the method comprising the steps of:
(a) providing the audio equipment, the equipment including a signal-emitting device and a headset;
(b) transmitting a signal from said signal-emitting device to said headset, and
(c) disposing a radio-frequency damping device such that radiation emitted by said signal-emitting device is reduced in the immediate vicinity of the sensitive organ.

2. The method of claim 1, wherein said audio equipment is a cellular phone.

3. The method of claim 2, wherein said damping device is a radiation filtering device.

4. The method of claim 2, wherein said damping device is a radiation blocking device.

5. The method of claim 4, wherein said radiation blocking device includes ferrite.

6. The method of claim 2, wherein said damping device is disposed on a cord connecting said signal-emitting device and said headset.

7. A headset for an audio device in which radiation emitted to a sensitive organ of a user is reduced, the headset comprising:
(a) at least one earphone;
(b) a cord operatively connected at a first end to said earphone, and operatively connected at a second end to the audio device, and
(c) a radio-frequency (RF) wave attenuating device, said RF wave attenuating device disposed so as to reduce the radiation emitted via the audio device to the sensitive organ.

8. The headset of claim 7, wherein said RF wave attenuating device is operatively connected to said cord.

9. The headset of claim 8, wherein the sensitive organ is a brain.

10. The headset of claim 9, wherein the audio device is a mobile phone.

11. The headset of claim 10, wherein said RF wave attenuating device is made of ferrite.

12. The headset of claim 11, wherein said RF wave attenuating device is substantially ring-shaped.

13. The headset of claim 12, wherein said RF wave attenuating device is substantially bead-shaped.

14. The headset of claim 10, wherein said RF wave attenuating device includes RF blocking electronic circuitry, and wherein said circuitry is electrically connected to said cord.

15. The headset of claim 10, wherein said RF blocking electronic circuitry includes a capacitor, a resistor, and an inductor wired in a network configuration.

16. The headset of claim 10, wherein said RF blocking electronic circuitry is a filter tuned to block the frequency of the communication device.

17. The headset of claim 8, wherein said RF wave attenuating device is an integral part of a connector connecting said cord to said RF wave attenuating device.

18. The headset of claim 8, wherein said RF wave attenuating device is an integral part of a microphone assembly disposed on said cord.

19. The headset of claim 8, wherein said RF wave attenuating device is an integral part of said cord, said RF wave attenuating device enveloping electric conductors running along a length of said cord.

20. The headset of claim 8, wherein said RF wave attenuating device includes a sound conducting tube made of a radio frequency inhibiting material.
